(19) United States
(12) Patent Application Publication
(10) Pub. No.: US 2019/0285412 A1
(43) Pub. Date: Sep. 19, 2019

(54) SYSTEM AND METHOD FOR AUTOMATICALLY ACQUIRING TWO-DIMENSIONAL IMAGES AND THREE-DIMENSIONAL POINT CLOUD DATA OF A FIELD TO BE SURVEYED

(71) Applicant: DATUMATE LTD., Yoqneam llit (IL)

(72) Inventors: Jad JARROUSH, Nazareth Illit (IL); Bishara KHELL, Nazareth (IL); Itay SEGEV, Hod Hasharon (IL); Younan S. HAKIM, Nazareth (IL)

(73) Assignee: DATUMATE LTD., Yoqneam llit (IL)

(21) Appl. No.: 16/346,600

(22) PCT Filed: Nov. 2, 2017
(86) PCT No.: PCT/IL2017/051201

§ 371 Date: May 1, 2019

Related U.S. Application Data
(60) Provisional application No. 62/416,780, filed on Nov. 3, 2016.

(51) Int. Cl. G01C 11/02; H04N 7/18; G06K 9/00; G08G 5/00

(52) U.S. Cl. CPC G01C 11/025; G08G 5/003; G06K 9/00637; H04N 7/181

(57) ABSTRACT

For a field to be surveyed, generating at least first and second flight plans, the first flight plan including a plurality of first way points, the second flight plan including a plurality of second way points, each of the second way points corresponding to one of the plurality of first way points, each of the first and second plurality of way points being together suitable for photographing an entirety of the field to be surveyed; and executing, in parallel, the first and second flight plans by corresponding first and second drones, the executing including, at each of the corresponding ones of the first way points and the second way points, simultaneously photographing first and second at least partially overlapping sections of the field by corresponding first and second drones, obtaining an absolute position of each of the first and second drones, and measuring a distance between the first and second drones.

### REFERENCE TO RELATED APPLICATIONS

Reference is made to U.S. Provisional Patent Application Ser. No. 62/416,780, filed Nov. 3, 2016 and entitled “SYSTEM AND METHOD FOR AUTOMATICALLY ACQUIRING TWO-DIMENSIONAL IMAGES AND THREE-DIMENSIONAL POINT CLOUD DATA OF A FIELD TO BE SURVEYED”, the disclosure of which is hereby incorporated by reference and priority of which is hereby claimed pursuant to 37 CFR 1.78(a) (4) and (5)(i).

### FIELD OF THE INVENTION

The present invention relates generally to systems and methods for executing surveys such as, for example, land surveys, engineering surveys, construction surveys and inspections, agricultural mapping and urban planning and mapping.

### BACKGROUND OF THE INVENTION

Current methods of executing surveys typically include generating a field sketch by manually sketching a field to be surveyed, naming and selecting a plurality of measuring points on the field sketch for which coordinate data is to be obtained, and obtaining the coordinate data corresponding to the measuring points by measuring the measuring points in the field using well-known field measuring techniques. It is appreciated that the field sketch is typically drawn relative to well known reference points such as cadastral reference points or a licensed control points.

Typically, the surveying crew includes at least two individuals, wherein one individual is tasked with drawing the sketch and another individual is tasked with measuring the previously selected measuring points by employing a geodetic measurement device such as, for example, a total station, a GPS RTK or any other suitable geodetic measurement device. Alternatively, the surveying crew may include only one individual tasked with drawing the sketch and supervising automatic measurement of the previously selected measuring points by a robotic geodetic measurement device.

The manual method described hereinabove is deemed to be error-prone, as the accuracy of the resulting survey is dependent on the accuracy of the manual sketch. An inaccurate sketch may result in a survey wherein the location of a measuring point on the sketch may not correspond to the actual location of the measured point as measured in the field.

Additionally, when employing the manual method described hereinabove, the surveyor in the field may erroneously omit from the manual sketch one or more significant topographical or structural features of the area in the field to be surveyed, thereby leading, in turn, to a survey which is lacking measurements corresponding to the omitted features. The result is a time-consuming and relatively expensive process, wherein the surveyor must return to the field time and time again to measure the omitted features.

The present invention seeks to provide improved systems and methods for acquiring two-dimensional images of a field to be surveyed and for automatically obtaining coordinate data for a plurality of measuring points in the field.

### SUMMARY OF THE INVENTION

The present invention seeks to provide an improved system and method for executing surveys, such as land surveys, engineering surveys and construction surveys.

There is thus provided in accordance with a preferred embodiment of the present invention a method for automatically acquiring two-dimensional images of a field to be surveyed and coordinate data thereof, the method including, for a given field to be surveyed, generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing an entirety of the field to be surveyed; and executing, in parallel, the first and second flight plans by corresponding first and second drones, the executing including, at each of the corresponding ones of the first way points and the second way points, simultaneously photographing first and second at least partially overlapping sections of the field by corresponding first and second drones, obtaining an absolute position of each of the first and second drones, and measuring a distance between the first and second drones.

Preferably, each of the way points includes a position at which a drone is to photograph the field and at least one of an angle of orientation between the drone and the field at which angle the drone is to photograph the field and a distance between the drone and a ground station at which distance said drone is to photograph said field.

Preferably, the method also includes, in each of the first and second at least partially mutually overlapping sections of the field, identifying a plurality of tie-points which appear in both of the first and second at least partially mutually overlapping sections of the field. Preferably, the method also includes calculating coordinate data of each of the tie points by utilizing the absolute positions of each of the first and second drones at each of the way-points, the distance between the first and second drones at each of the way-points and at least one of an angle of orientation between each of the first and second drones and the field at each of the way-points and a distance between each of the first and second drones and a ground station at each of the way-points.

There is also provided in accordance with another preferred embodiment of the present invention a method for remotely automatically obtaining two-dimensional images of a field to be surveyed and coordinate data thereof, the method including providing, by a requesting entity, a request for coordinate data of a plurality of measuring points to be measured in the field; automatically generating a flight plan to be executed by a drone, which flight plan is operative to direct the drone over the field, the flight plan including a multiplicity of way-points at which the drone is to photograph the field and to measure the plurality of measuring points; publishing the automatically generated flight plan to a multiplicity of service providers; providing, by at least some of the service providers to the requesting entity, a quote for executing the automatically generated flight plan; selecting, by the requesting entity, at least one of the at least some of the service providers; executing, by the selected one of the at least some of the service providers, the automatically generated flight plan; and providing, by the selected one of the at least some of the service providers, coordinate data of the plurality of measuring points to the requesting entity.

Preferably, each of the way points includes a position at which a drone is to photograph the field and at least one of an angle of orientation between the drone and the field at which angle the drone is to photograph the field and a distance between the drone and a ground station at which distance the drone is to photograph the field.

There is further provided in accordance with yet another preferred embodiment of the present invention a method for remotely automatically obtaining two-dimensional images of a field to be surveyed and coordinate data thereof, the method including providing, by a requesting entity, a request for coordinate data of a plurality of measuring points to be measured in the field; automatically generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing and measuring all of the plurality of measuring points, each of the way points including a position at which a drone is to photograph the field and at least one of an angle of orientation between the drone and the field at which angle the drone is to photograph the field and a distance between the drone and a ground station at which distance the drone is to photograph the field; publishing the first and second automatically generated flight plans to a multiplicity of service providers; providing, by at least some of the service providers to the requesting entity, a quote for executing the first and second automatically generated flight plans; selecting, by the requesting entity, one of the at least some of the service providers; executing, by the selected one of the at least some of the service providers, in parallel, the first and second automatically generated flight plans by corresponding first and second drones, the executing including, at each of the corresponding ones of the first way points and the second way points simultaneously photographing first and second at least partially overlapping sections of the field by corresponding first and second drones obtaining an absolute position of each of the first and second drones, measuring a distance between the first and second drones, identifying a plurality of tie-points which appear in both of the first and second at least partially mutually overlapping sections of the field, at least some of the tie-points corresponding to the plurality of measuring points and calculating coordinate data of each of the tie points corresponding to the plurality of measuring points by utilizing the absolute positions of each of the first and second drones at each of the way-points, the distance between the first and second drones at each of the way-points and at least one of an angle of orientation between each of the first and second drones and the field at each of the way-points and a distance between each of the first and second drones and a ground station at each of the way-points; and providing, by the selected one of the at least some of the service providers, the coordinate data of the plurality of measuring points to the requesting entity.

There is yet further provided in accordance with yet another preferred embodiment of the present invention a building information modeling method including for a given construction-site to be surveyed, generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing an entirety of the construction-site to be surveyed; executing, in parallel, the first and second flight plans by corresponding first and second drones, the executing including, at each of the corresponding ones of the first way points and the second way points simultaneously photographing first and second at least partially overlapping sections of the construction-site by corresponding first and second drones; and, in each of the photographs of the first and second at least partially mutually overlapping sections of the construction-site, identifying a plurality of tie-points which appear in both of the first and second at least partially mutually overlapping sections of the construction-site, at least some of the tie-points corresponding to physical unique camera-identifiable markers located throughout the construction-site, thereby generating a three-dimensional point cloud of the construction site.

Preferably, each of the way points includes a position at which a drone is to photograph the construction-site and at least one of an angle of orientation between the drone and the construction-site at which angle the drone is to photograph the construction-site and a distance between the drone and at least one of the physical unique camera-identifiable markers.

Preferably, the method also includes ascertaining coordinate data of at least some of the tie points by retrieving and employing pre-measured three-dimensional absolute coordinates of each of the corresponding physical unique camera-identifiable markers.

Preferably, the method also includes comparing consecutive ones of the acquired three-dimensional point clouds of the construction site to track progress of a construction project on the construction site.

There is yet further provided in accordance with yet another preferred embodiment of the present invention a system for automatically acquiring two-dimensional images of a field to be surveyed and coordinate data thereof, the system including a flight plan generator operable, for a given field to be surveyed, for generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing an entirety of the field to be surveyed, and at least a first and a second drone operable for executing, in parallel, the first and second flight plans by corresponding first and second drones, the executing including, at each of the corresponding ones of the first way points and the second way points, simultaneously photographing first and second at least partially overlapping sections of the field by corresponding first and second drones, obtaining an absolute position of each of the first and second drones, and measuring a distance between the first and second drones.

Preferably, each of the way points includes a position at which a drone is to photograph the field and at least one of an angle of orientation between the drone and the field at which angle the drone is to photograph the field and a distance between the drone and a ground station at which distance the drone is to photograph the field.

Preferably, the system also in includes a tie-point analyzer operable, in each of the first and second at least partially mutually overlapping sections of the field, for identifying a plurality of tie-points which appear in both of the first and second at least partially mutually overlapping sections of the field. Preferably, the tie-point analyzer is also operable for calculating coordinate data of each of the tie points by utilizing the absolute positions of each of the first and second drones at each of the way-points, the distance between the first and second drones at each of the way-points, and at least one of an angle of orientation between each of the first and second drones and the field at each of the way-points and a distance between each of the first and second drones and a ground station at each of the way-points.

There is yet further provided in accordance with yet another preferred embodiment of the present invention a system for remotely automatically obtaining two-dimensional images of a field to be surveyed and coordinate data thereof, the system including a coordinate data requestor operable for facilitating providing, by a requesting entity, a request for coordinate data of a plurality of measuring points to be measured in the field; a flight plan generator operable for automatically generating a flight plan to be executed by a drone, which flight plan is operative to direct the drone over the field, the flight plan including a multiplicity of way-points at which the drone is to photograph the field and to measure the plurality of measuring points; a flight plan publisher operable for publishing the automatically generated flight plan to a multiplicity of service providers; a flight plan quote provider operable for facilitating providing, by at least some of the service providers to the requesting entity, a quote for executing the automatically generated flight plan; and a service provider selector operable for facilitating selecting, by the requesting entity, at least one of the at least some of the service providers, for executing the automatically generated flight plan and for providing coordinate data of the plurality of measuring points to the requesting entity.

Preferably, each of the way points includes a position at which a drone is to photograph the field, and at least one of an angle of orientation between the drone and the field at which angle the drone is to photograph the field and a distance between the drone and a ground station at which distance the drone is to photograph the field.

There is yet further provided in accordance with yet another preferred embodiment of the present invention a system for remotely automatically obtaining two-dimensional images of a field to be surveyed and coordinate data thereof, the system including a coordinate data requestor operable for facilitating providing, by a requesting entity, a request for coordinate data of a plurality of measuring points to be measured in the field; a flight plan generator operable for automatically generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing and measuring all of the plurality of measuring points, each of the way points including a position at which a drone is to photograph the field, and at least one of an angle of orientation between the drone and the field at which angle the drone is to photograph the field and a distance between the drone and a ground station at which distance the drone is to photograph the field; a flight plan publisher operable for publishing the first and second automatically generated flight plans to a multiplicity of service providers; a flight plan quote provider operable for facilitating providing, by at least some of the service providers to the requesting entity, a quote for executing the first and second automatically generated flight plans; a service provider selector operable for facilitating selecting, by the requesting entity, one of the at least some of the service providers for executing, in parallel, the first and second automatically generated flight plans by corresponding first and second drones, the executing including, at each of the corresponding ones of the first way points and the second way points simultaneously photographing first and second at least partially overlapping sections of the field by corresponding first and second drones; obtaining an absolute position of each of the first and second drones; measuring a distance between the first and second drones; identifying a plurality of tie-points which appear in both of the first and second at least partially mutually overlapping sections of the field, at least some of the tie-points corresponding to the plurality of measuring points; and calculating coordinate data of each of the tie points corresponding to the plurality of measuring points by utilizing the absolute positions of each of the first and second drones at each of the way-points; the distance between the first and second drones at each of the way-points; and at least one of an angle of orientation between each of the first and second drones and the field at each of the way-points and a distance between each of the first and second drones and a ground station at each of the way-points; and providing the coordinate data of the plurality of measuring points to the requesting entity.

There is yet further provided in accordance with yet another preferred embodiment of the present invention a building information modeling system including a flight plan generator operable, for a given construction-site to be surveyed, for generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing an entirety of the construction-site to be surveyed; at least a first and a second drone operable for executing, in parallel, the first and second flight plans by corresponding first and second drones, the executing including, at each of the corresponding ones of the first way points and the second way points, simultaneously photographing first and second at least partially overlapping sections of the construction-site by corresponding first and second drones; and a tie-point analyzer operable, in each of the photographs of the first and second at least partially mutually overlapping sections of the construction-site, for identifying a plurality of tie-points which appear in both of the first and second at least partially mutually overlapping sections of the construction-site, at least some of the tie-points corresponding to physical unique camera-identifiable markers located throughout the construction-site, thereby generating a three-dimensional point cloud of the construction site.

Preferably, each of the way points includes a position at which a drone is to photograph the construction-site and at least one of an angle of orientation between the drone and the construction-site at which angle the drone is to photograph the construction-site and a distance between the drone and at least one of the physical unique camera-identifiable markers.

Preferably, the tie-point analyzer is also operable for ascertaining coordinate data of at least some of the tie points by retrieving and employing pre-measured three-dimensional absolute coordinates of each of the corresponding physical unique camera-identifiable markers.

Preferably, the building information modeling system also includes a building information modeler operable for comparing consecutive ones of the acquired three-dimensional point clouds of the construction site to track progress of a construction project on the construction site.

### BRIEF DESCRIPTION OF THE DRAWINGS

The present invention will be understood and appreciated more fully from the following detailed description, taken in conjunction with the drawings in which:

FIGS. 1-4 are simplified pictorial illustrations of the operation of a method and system for automatically acquiring a two-dimensional image of a field to be surveyed and coordinate data thereof in accordance with a preferred embodiment of the present invention;

FIG. 5 is a simplified block diagram illustration of a system which implements the method of FIGS. 1-4.

FIG. 6 is a simplified flowchart illustration illustrating steps in the operation of a method and system for remotely obtaining a two-dimensional image of a field and coordinate data thereof in accordance with another preferred embodiment of the present invention;

FIG. 7 is a simplified block diagram illustration of a system which implements the method of FIG. 6;

FIGS. 8, 9A, 9B, 10A and 10B are simplified pictorial illustrations of the operation of a Building Information Modeling (BIM) system in accordance with yet another preferred embodiment of the present invention; and

FIG. 11 is a simplified block diagram illustration of the Building Information Modeling (BIM) system of FIGS. 8, 9A, 9B, 10A and 10B.

### DETAILED DESCRIPTION OF PREFERRED EMBODIMENTS

The present invention seeks to provide improved systems and methods for acquiring two-dimensional images of a field to be surveyed and for automatically obtaining coordinate data for a plurality of measuring points in the field.

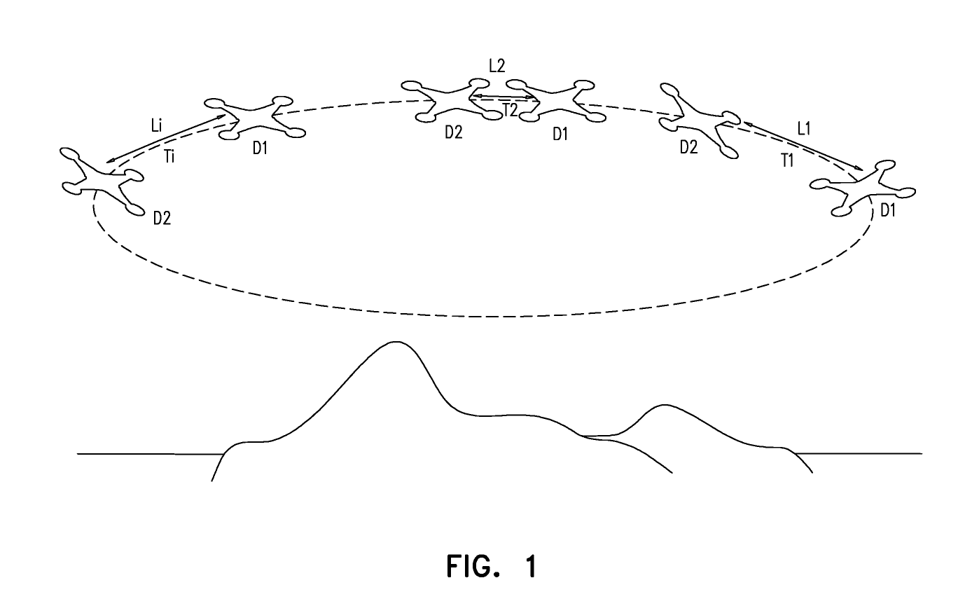

In a first embodiment illustrated in FIG. 1, at least two unmanned aerial vehicles (UVAs) such as drones D1 and D2 are employed. Drone helicopters are particularly suited for executing the method of the present embodiment, however any other suitable flying device may be employed. It is appreciated that, alternatively, only one unmanned UVA may be employed to photograph the field, whereby accurate positioning of the UVA at each way point is preferably obtained by communicating with a ground station located at a location known the system.

Preferably, each of drones D1 and D2 is provided with a pre-defined flight plan which will direct the drone over the field. Each flight plan preferably includes a multiplicity of way-points at which the drone is to photograph the field, each way-point preferably including a position at which to photograph the field, and at least one of an angle of orientation between the drone and the ground at which to photograph the field and a distance between the drone and a ground station at which to photograph the field. Drones D1 and D2 may direct themselves to each of the way-points, for example, by employing GPS positioning. It is appreciated that the way-points are preferably selected to photograph specific areas of interest in the field. It is further appreciated that the way points of each of the flight plans of drones D1 and D2 are together suitable for photographing an entirety of the field.

As further shown in FIG. 1, each of drones D1 and D2 preferably photographs the field from each of the predefined way-points at mutually synchronized times (t₁, t₂ . . . tₙ). At each synchronized time tᵢ a distance vector Lᵢ is preferably measured between drones D1 and D2 by employing methods which are well known in the art, such as by laser or by any other suitable electromagnetic distance measurement method.

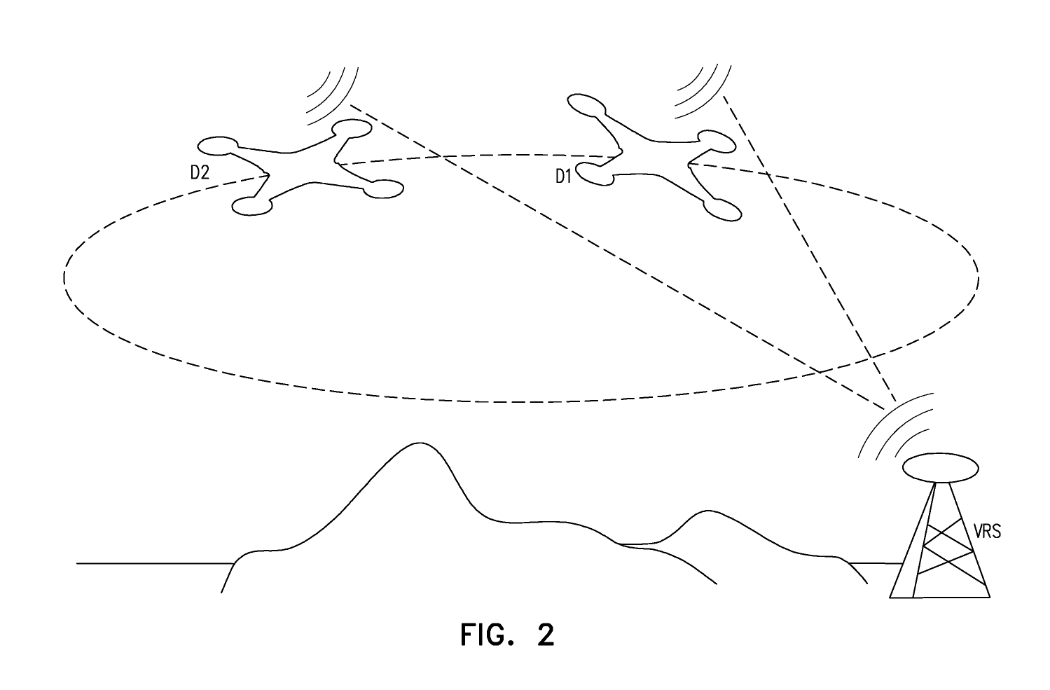

Additionally, as shown in FIG. 2, each of drones D1 and D2 preferably employs RTK positioning using VRS to obtain absolute positioning information thereof.

It is a particular feature of this embodiment of the present invention that while RTK positioning using VRS is relatively accurate, comparison of the position of each of drones D1 and D2 thereby obtained to the distance vector Lᵢ therebetween is operative to obtain yet further accurate positioning of drones D1 and D2.

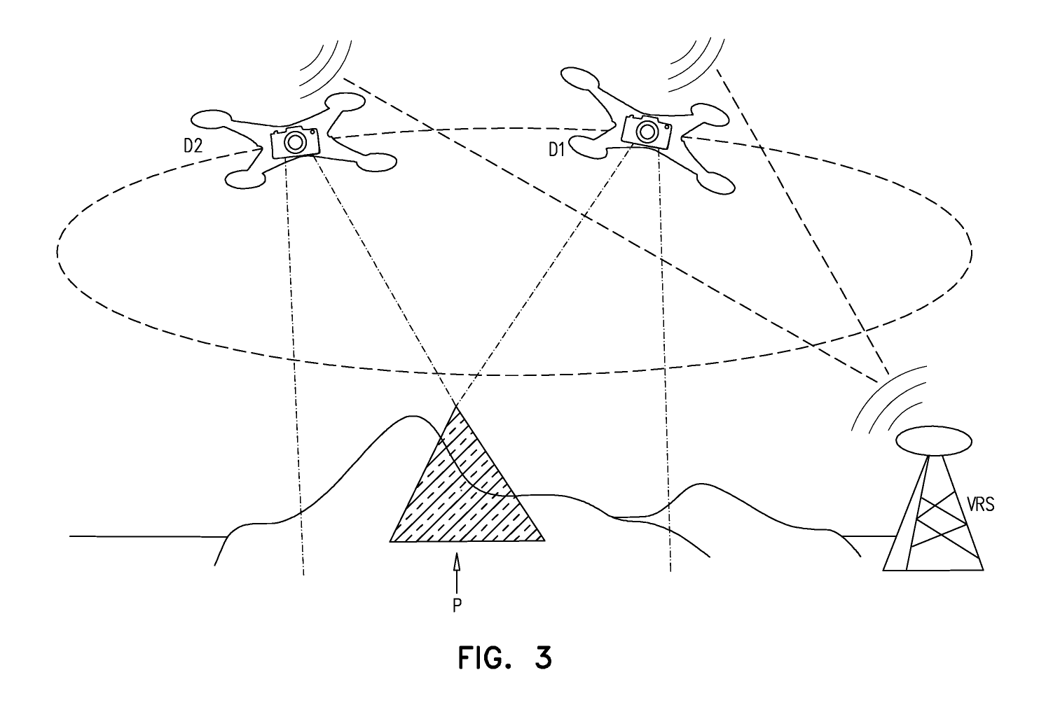

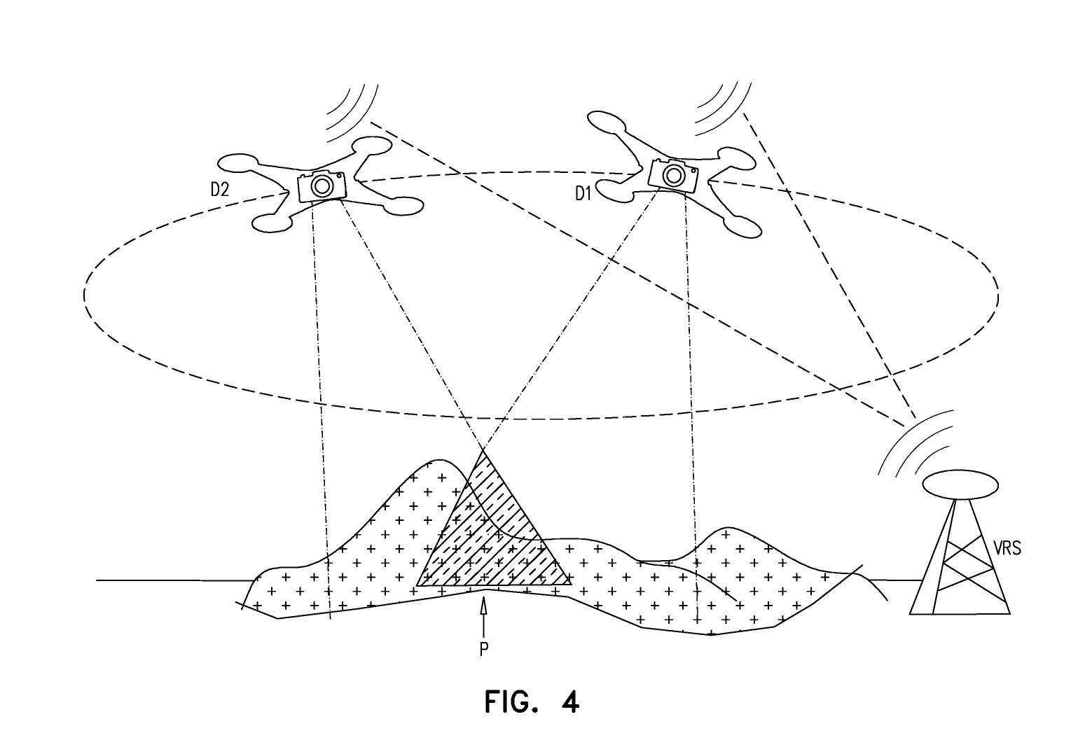

Turning now to FIG. 3, it is shown that at each of times (t₁, t₂ . . . tₙ) each of drones D1 and D1 preferably photographs overlapping sections of the field. As shown in FIG. 4, when comparing the photographs of the overlapping sections of the field taken by corresponding drones D1 and D2, a plurality of tie points P are preferably identified by employing methods which are well known in the art.

It is a particular feature of this embodiment of the present invention that by employing the positions of drones D1 and D2, distance vector Lᵢ therebetween, and at least one of the angle of orientation between each of drones D1 and D2 and the ground and a distance between each of drones D1 and D2 and a ground station, an accurate position of each of the tie points is automatically obtained, thereby generating a three-dimensional point cloud of the field.

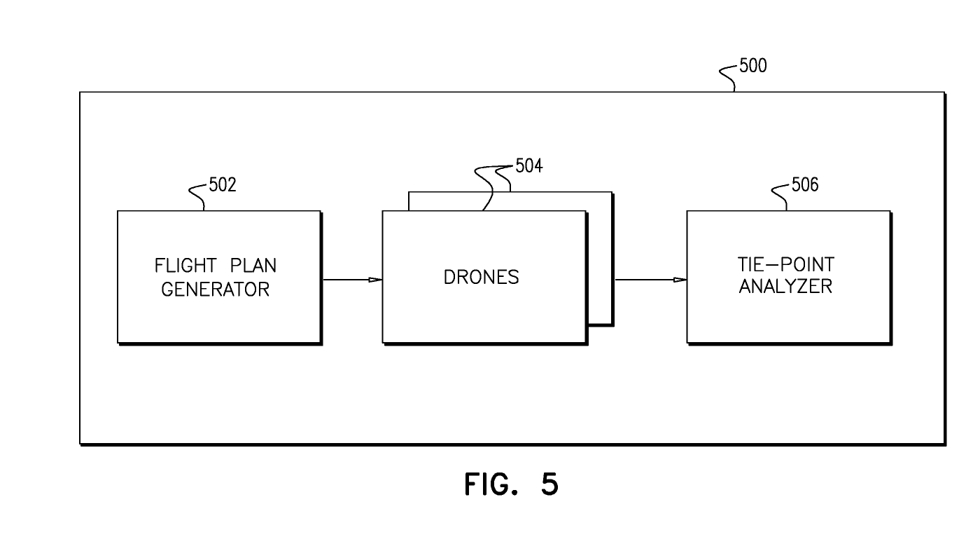

Reference is now made to FIG. 5, which is a simplified block diagram illustration of a system which implements the method of FIGS. 1-4. A shown in FIG. 5, a system for automatically acquiring two-dimensional images of a field to be surveyed and coordinate data thereof 500 preferably includes a flight plan generator 502 operable, for a given field to be surveyed, for generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing an entirety of the field to be surveyed.

System 500 also preferably includes at least first second drones 504 operable for executing, in parallel, the first and second flight plans by corresponding first and second drones. Executing the flight plans preferably included, at each of the corresponding ones of the first way points and the second way points, simultaneously photographing first and second at least partially overlapping sections of the field by corresponding first and second drones, obtaining an absolute position of each of the first and second drones, and measuring a distance between the first and second drones. As described hereinabove, each of the way points preferably includes a position at which a drone is to photograph the field, and at least one of an angle of orientation between the drone and the field at which angle the drone is to photograph the field, and a distance between the drone and a ground station at which distance the drone is to photograph the field.

System 500 also preferably includes a tie-point analyzer 506 operable, in each of the first and second at least partially mutually overlapping sections of the field, for identifying a plurality of tie-points which appear in both of the first and second at least partially mutually overlapping sections of the field. Tie-point analyzer 506 is preferably also operable for calculating coordinate data of each of the tie points by utilizing the absolute positions of each of the first and second drones at each of the way-points, the distance between the first and second drones at each of the way-points, and at least one of an angle of orientation between each of the first and second drones and the field at each of the way-points and a distance between each of the first and second drones and a ground station at each of the way-points.

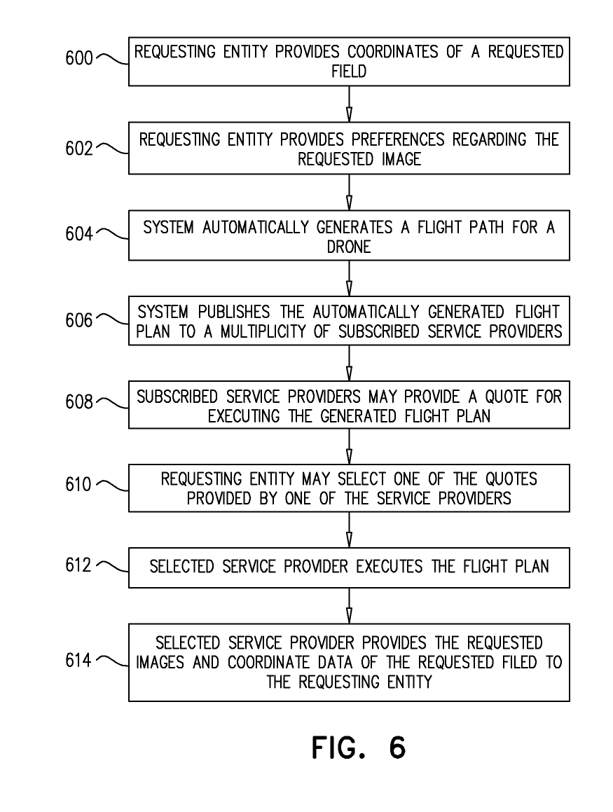

Reference is now made to FIG. 6, which is a simplified flowchart illustration illustrating steps in the operation of a method and system for remotely obtaining a two-dimensional image of a field and coordinate data thereof in accordance with another preferred embodiment of the present invention.

As shown in FIG. 6, an entity requesting a two-dimensional image of a field preferably initially accesses a system for requesting two-dimensional field images and preferably provides a set of coordinates defining a polygon encompassing the requested field (600). It is appreciated that, for example, the field for which the image is requested is typically at a location which is remote from the requesting entity, and is therefore unable to readily acquire the image manually. Alternatively, for example, the requesting entity is not equipped or staffed for obtaining the image independently.

Preferably, as shown in step 602, the requesting entity provides preferences regarding the requested image. For example, the requesting entity may request images of the field, coordinate data corresponding to a multiplicity of designated measuring points, a point cloud associated with the field, or a scaled map.

Responsive to receiving the details regarding the field and the requested images and associated data, the system preferably automatically generates a flight plan for a drone (604), which flight plan will direct the drone over the requested field and over any points within the field for which coordinate data has been requested. It is appreciated that the flight plan preferably includes a multiplicity of way-points at which the drone is to photograph the field, each way-point preferably including a position at which to take a photograph, and at least one of an angle of orientation between the drone and the ground at which to take the photograph and a distance between the drone and a ground station at which to take the photograph. It is further appreciated that multiple flight plans for execution by multiple drones may be generated.

The system then preferably publishes the automatically generated flight plans to each of a multiplicity of service providers who have subscribed to the system (606). Each of the subscribed service providers preferably operate drones in particular geographical areas, which drones are capable of executing the flights plans generated by the system. Upon receiving the generated flight plans, any of the subscribed service providers may then provide a quote for executing the generated flight plans to the requesting entity (608).

Upon receiving a multiplicity of quotes, the requesting entity may then select one of the quotes provided by one of the service providers (610), which selected service provider then executes the flight plans (612). As described hereinabove with respect to FIGS. 1-4, execution of two flight plans by two drones preferably includes:

simultaneously photographing first and second at least partially overlapping sections of a field by corresponding first and second drones;

obtaining an absolute position of each of the first and second drones;

measuring a distance between the first and second drones;

identifying a plurality of tie-points which appear in both of the first and second at least partially mutually overlapping sections of the field, at least some of the tie-points corresponding to the plurality of measuring points; and

calculating coordinate data of each of the tie points corresponding to the plurality of measuring points by utilizing absolute positions of each of the first and second drones at each of the way-points, the distance between the first and second drones at each of the way-points, and at least one of an angle of orientation between the drone and the field at each of the way-points and a distance between the drone and a ground station at each of the way-points.

Subsequently, the selected service provider then preferably provides the requested images and coordinate data of the requested filed to the requesting entity (614).

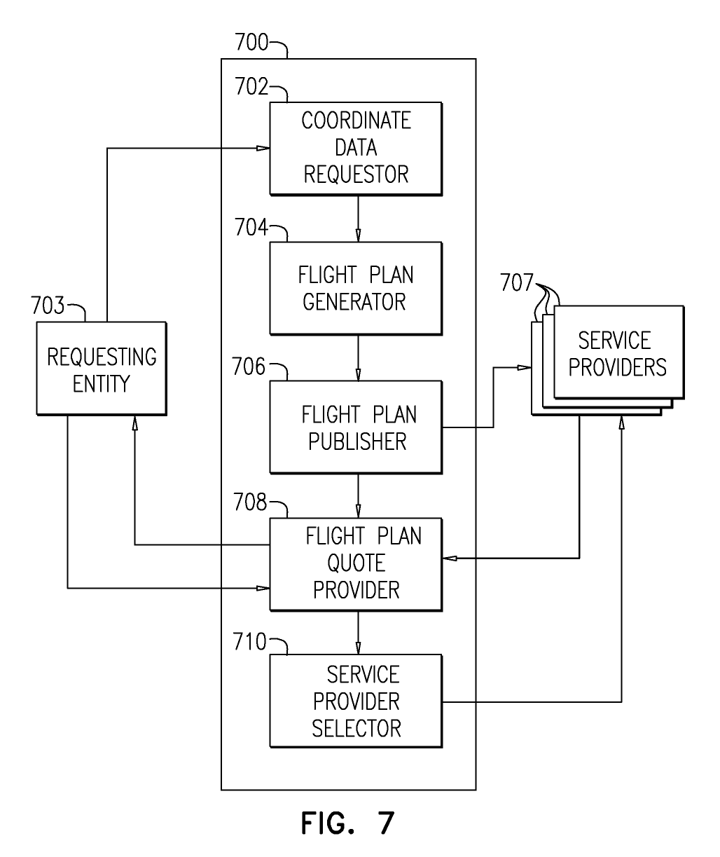

Reference is now made to FIG. 7, which is a simplified block diagram illustration of a system which implements the method of FIG. 6. As shown in FIG. 7, a system for remotely automatically obtaining two-dimensional images of a field to be surveyed and coordinate data thereof 700 preferably includes a coordinate data requestor 702 operable for facilitating providing, by a requesting entity 703, a request for coordinate data of a plurality of measuring points to be measured in the field.

A flight plan generator 704 is preferably provided for automatically generating a flight plan to be executed by a drone, which flight plan is operative to direct the drone over the field, the flight plan including a multiplicity of way-points at which the drone is to photograph the field and to measure the plurality of measuring points. When employed in conjunction with the example of FIGS. 1-4, flight plan generator 704 is preferably operable for automatically generating at least a first flight plan and a second flight plan, the first flight plan comprising a plurality of first way points, said second flight plan comprising a plurality of second way points, each of the second way points corresponding to one of the plurality of first way points, each of the plurality of first way points and the plurality of second way points being together suitable for photographing and measuring all of the plurality of measuring points.

As described hereinabove, it is appreciated that each of the way points preferably includes a position at which a drone is to photograph the field, and at least one of an angle of orientation between the drone and the field at which angle the drone is to photograph the field and a distance between the drone and a ground station at which distance the drone is to photograph the field.

A flight plan publisher 706 is provided for publishing the automatically generated flight plans to a multiplicity of service providers 707, and a flight plan quote provider 708 is provided for facilitating providing, by at least some of service providers 707 to requesting entity 703, a quote for executing the automatically generated flight plan.

A service provider selector 710 is preferably provided for facilitating selecting, by requesting entity 703, at least one of service providers 707, for executing the automatically generated flight plans and for providing coordinate data of the plurality of measuring points to the requesting entity. When employed in conjunction with the example of FIGS. 1-4, service provider selector 710 is preferably operable for executing, in parallel, the first and second automatically generated flight plans by corresponding first and second drones, the executing including, at each of the corresponding ones of the first way points and the second way points:

simultaneously photographing first and second at least partially overlapping sections of the field by corresponding first and second drones;

obtaining an absolute position of each of the first and second drones;

measuring a distance between the first and second drones;

identifying a plurality of tie-points which appear in both of the first and second at least partially mutually overlapping sections of the field, at least some of the tie-points corresponding to the plurality of measuring points; and

calculating coordinate data of each of the tie points corresponding to the plurality of measuring points by utilizing the absolute positions of each of the first and second drones at each of the way-points, the distance between the first and second drones at each of the way-points, and at least one of an angle of orientation between each of the first and second drones and the field at each of the way-points and a distance between each of the first and second drones and a ground station at each of the way-points; and

In an alternative embodiment of the present invention, a Building Information Modeling (BIM) system is provided. The BIM system of the present invention is preferably operable for tracking actual progress of large-scale construction projects, based on up-to-date three-dimensional point clouds generated by processing a multiplicity of two-dimensional images of the construction sites.

As described hereinabove with respect to a first embodiment of the present invention, UVAs may be employed to acquire images of a construction site to be surveyed by flying over way-points which are pre-designated in a flight plan executed by the UAVs. It is appreciated that the flight plan may be pre-scheduled to be executed at predetermined intervals of time. The unmanned nature of the UVAs and the capacity for providing pre-scheduled flight plans to the UVAs facilitates control of the system by an individual who may not be physically present at the construction site at the time of execution of the flight plans.

In the present embodiment of the present invention, a plurality of locations throughout a construction site may be physically marked by placing physical unique camera-identifiable markers at each of the locations, the three-dimensional absolute coordinates of which markers being pre-measured and known to the system.

As described hereinabove with respect to the first embodiment of the present invention, at least two unmanned aerial vehicles (UVAs) are preferably employed to photograph the construction site. Drone helicopters are particularly suited for executing the method of the present embodiment, however any other suitable flying device may be employed.

It is further appreciated that, alternatively, only one unmanned UVA may be employed to photograph the construction site, whereby accurate positioning of the UVA at each way point is preferably obtained by communicating with a ground station located at a location known the system.

It is appreciated that photographing large construction sites may be relatively time consuming, and that the UVAs employed are therefore typically capable, while executing a flight plan, of returning to a charging station when necessary and thereafter returning to the construction site to execute a remainder of the flight plan. The UVA may be charged at the charging station, for example, automatically or by manually replacing a battery mounted thereupon.

Preferably, each of the drones is provided with a pre-defined flight plan which will direct the drone over the construction site. Each flight plan preferably includes a multiplicity of way-points at which the drone is to photograph the construction site, each way-point preferably including a position at which to photograph the construction site, and at least one of an angle of orientation between the drone and the ground at which to photograph the construction site and a distance between the drone and a ground station at which to photograph the construction site. The drones may direct themselves to each of the way-points, for example, by employing GPS positioning. It is appreciated that the way-points are preferably selected to photograph specific areas of interest in the construction site.

As further described hereinabove, each of the drones preferably photographs overlapping sections of the construction site from each of the predefined way-points at mutually synchronized times. It is appreciated that when comparing the photographs of the overlapping sections of the construction site taken by the drones, tie points corresponding to the aforementioned physical unique camera-identifiable markers are preferably identified by employing methods which are well known in the art.

It is a particular feature of this embodiment of the present invention that an accurate position of at least some of the tie points is automatically obtained by identifying the corresponding physical unique camera-identifiable markers and by retrieving the pre-measured three-dimensional absolute coordinates associated therewith.

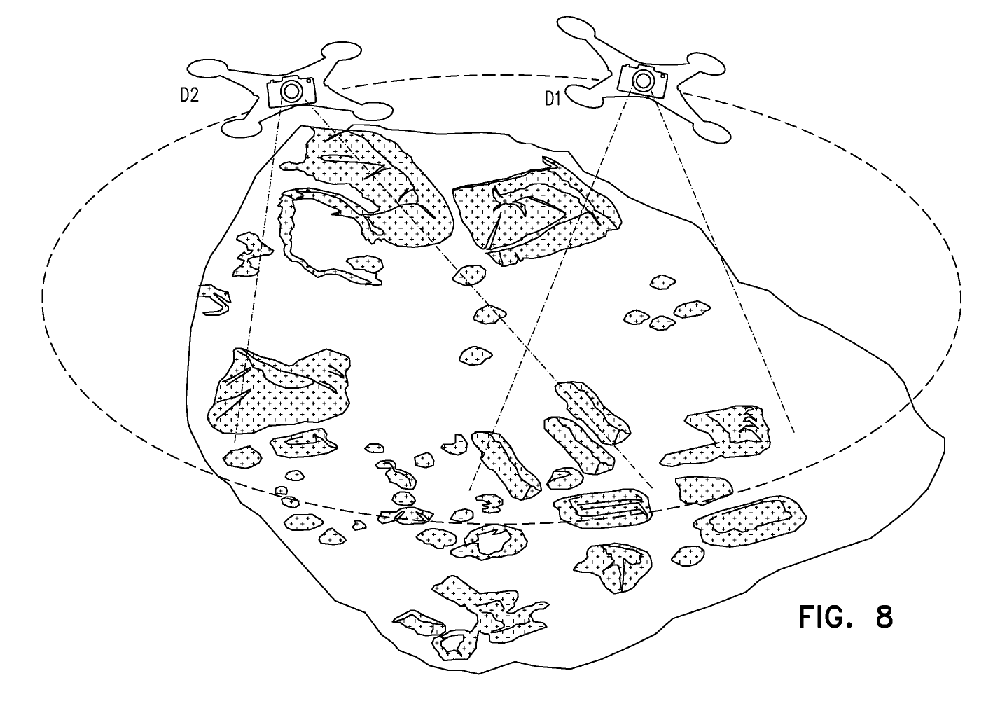

It is appreciated that by employing at least two overlapping two-dimensional photographs of each section of the construction site, a three dimensional point cloud of the construction site, such as the point cloud illustrated in FIG. 8, is automatically obtained by employing methods which are well known in the art. It is further appreciated that while employing human surveyors to create an accurate image of a construction site is costly time consuming and often inaccurate and outdated, employing UAVs allows frequent generation of accurate and up-to-date three dimensional point clouds of a construction site. By frequently generating such point clouds of a particular construction site and by comparing consecutive sets of point clouds of the particular construction site, tracking of actual progress the construction project at the construction site is thereby facilitated.

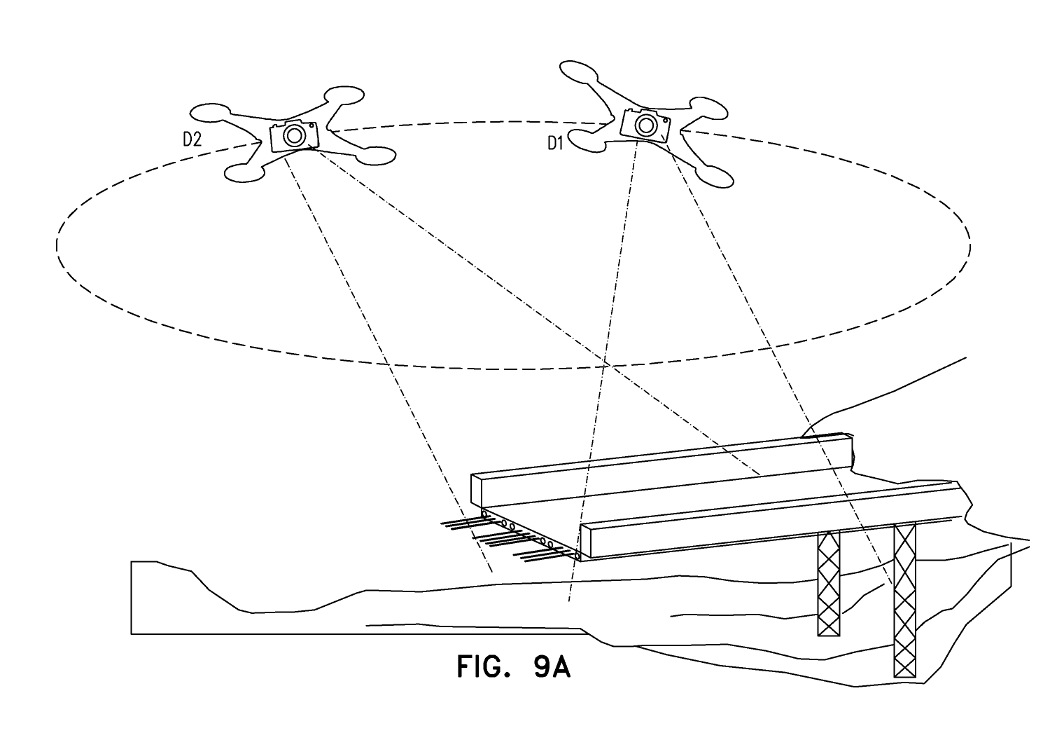

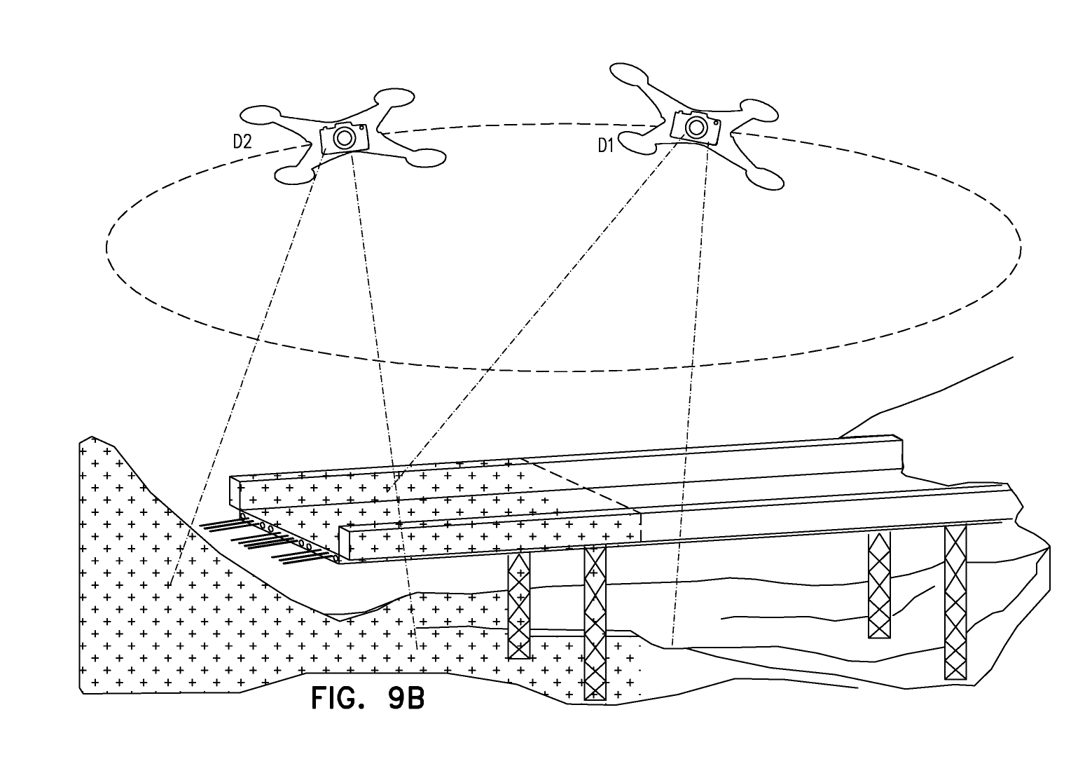

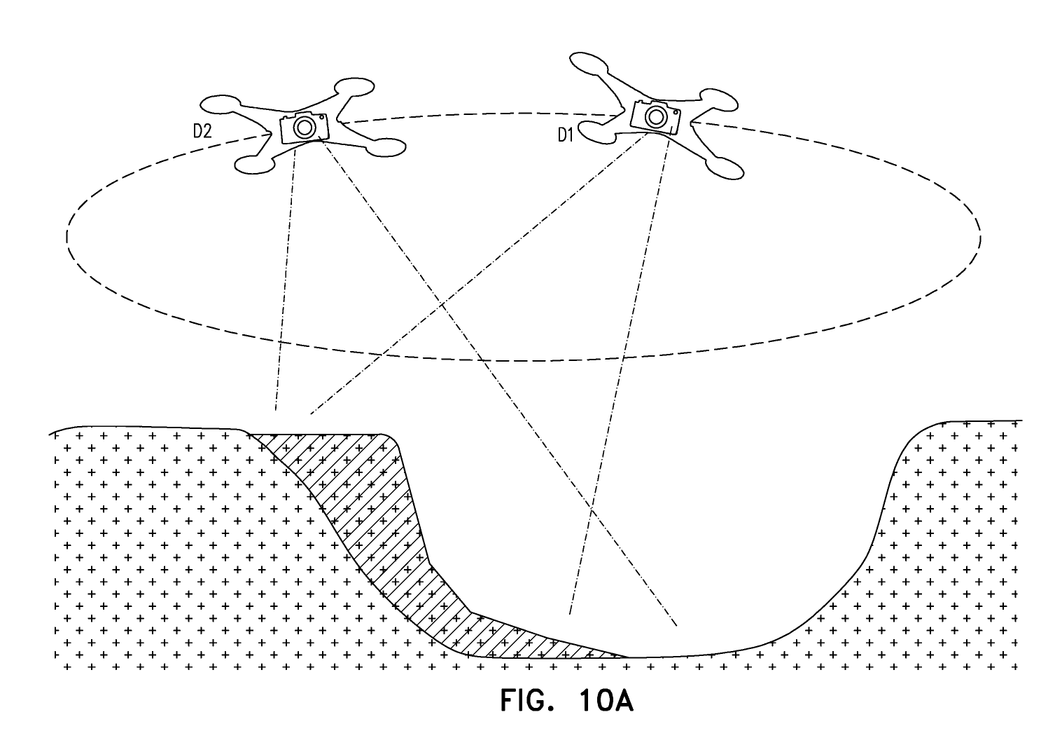

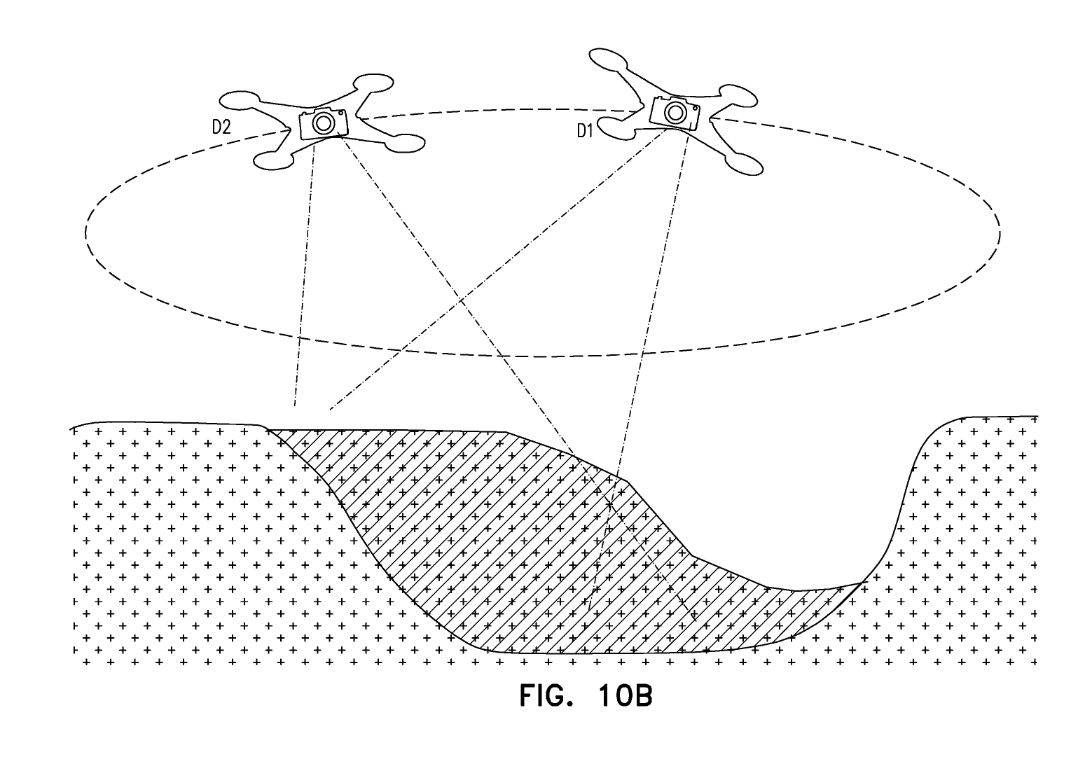

Furthermore, for example, comparison of two sets of three dimensional point clouds of a construction site taken at different times facilitates calculation of a difference in height of a particular element of the construction project between two points in time, which in turn corresponds to progress made in construction of that particular element. For example, as shown in FIGS. 9A & 9B, a difference in the length of a bridging element, corresponding to progress in construction of the element, may be calculated. Furthermore, for example, as shown in FIGS. 10A & 10B, a difference in the elevation of a particular location may correspond to progress made in filling a landfill or in elevating a roadbed, or to progress made in the excavation of a pier. It is appreciated that the aforementioned progress made in a particular construction element may serve as a basis for calculating an amount of raw material which was, for example, employed, consumed or removed from a particular construction site. It is further appreciated that these calculated amounts of raw material manipulated during the course of a construction project are important indicators of progress and expenditure of a project.

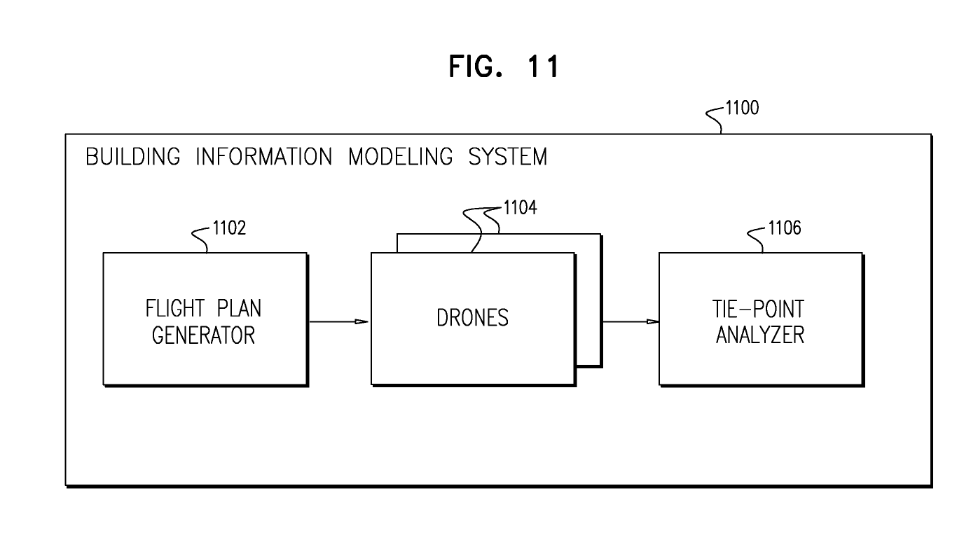

Reference is now made to FIG. 11, which is a simplified block diagram illustration of the Building Information Modeling (BIM) system of FIGS. 8, 9A, 9B, 10A and 10B. The building information modeling system 1100 preferably includes a flight plan generator 1102 operable, for a given construction-site to be surveyed, for generating at least a first flight plan and a second flight plan, the first flight plan including a plurality of first way points, the second flight plan including a plurality of second way points, each of the second way points corresponding to one of the plurality of first way points, each of the plurality of first way points and the plurality of second way points being together suitable for photographing an entirety of the construction-site to be surveyed.

At least first and second drones 1104 are provided for executing, in parallel, the first and second flight plans by corresponding first and second drones 1104, the executing including, at each of the corresponding ones of the first way points and the second way points, simultaneously photographing first and second at least partially overlapping sections of the construction-site by corresponding first and second drones.

A tie-point analyzer 1106 is preferably operable, in each of the photographs of the first and second at least partially mutually overlapping sections of the construction-site, for identifying a plurality of tie-points which appear in both of the first and second at least partially mutually overlapping sections of the construction-site, at least some of the tie-points corresponding to physical unique camera-identifiable markers located throughout the construction-site, thereby generating a three-dimensional point cloud of the construction site.

It is appreciated that each of the way points preferably includes a position at which a drone is to photograph the construction-site, and at least one of an angle of orientation between the drone and the construction-site at which angle the drone is to photograph the construction-site and a distance between the drone and at least one of the physical unique camera-identifiable markers.

Tie-point analyzer 1106 is preferably also operable for ascertaining coordinate data of at least some of the tie points by retrieving and employing pre-measured three-dimensional absolute coordinates of each of the corresponding physical unique camera-identifiable markers.

Building information modeling system 1100 also preferably includes a building information modeler 1108 operable for comparing consecutive ones of the acquired three-dimensional point clouds of the construction site to track progress of a construction project on the construction site.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A method for automatically acquiring two-dimensional images of a field to be surveyed and coordinate data thereof, said method comprising:
for a given field to be surveyed, generating at least a first flight plan and a second flight plan, said first flight plan comprising a plurality of first way points, said second flight plan comprising a plurality of second way points, each of said second way points corresponding to one of said plurality of first way points, each of said plurality of first way points and said plurality of second way points being together suitable for photographing an entirety of said field to be surveyed; and
executing, in parallel, said first and second flight plans by corresponding first and second drones, said executing comprising, at each of said corresponding ones of said first way points and said second way points:
simultaneously photographing first and second at least partially overlapping sections of said field by corresponding said first and second drones;
obtaining an absolute position of each of said first and second drones; and
measuring a distance between said first and second drones.

2. A method according to claim 1 and wherein each of said way points comprises:
a position at which a drone is to photograph said field; and
at least one of:
an angle of orientation between said drone and said field at which angle said drone is to photograph said field; and
a distance between said drone and a ground station at which distance said drone is to photograph said field.

3. A method according to claim 2 and also comprising:
in each of said first and second at least partially mutually overlapping sections of said field:
identifying a plurality of tie-points which appear in both of said first and second at least partially mutually overlapping sections of said field; and
calculating coordinate data of each of said tie points by utilizing:
said absolute positions of each of said first and second drones at each of said way-points;
said distance between said first and second drones at each of said way-points; and
at least one of:
an angle of orientation between each of said first and second drones and said field at each of said way-points; and
a distance between each of said first and second drones and a ground station at each of said way-points.

4. (canceled)

5. A method for remotely automatically obtaining two-dimensional images of a field to be surveyed and coordinate data thereof, said method comprising:
providing, by a requesting entity, a request for coordinate data of a plurality of measuring points to be measured in said field;
automatically generating a flight plan to be executed by a drone, which flight plan is operative to direct said drone over said field, said flight plan comprising a multiplicity of way-points at which said drone is to photograph said field and to measure said plurality of measuring points;
publishing said automatically generated flight plan to a multiplicity of service providers;
providing, by at least some of said service providers to said requesting entity, a quote for executing said automatically generated flight plan;
selecting, by said requesting entity, at least one of said at least some of said service providers;
executing, by said selected one of said at least some of said service providers, said automatically generated flight plan; and
providing, by said selected one of said at least some of said service providers, coordinate data of said plurality of measuring points to said requesting entity.

6. A method according to claim 5 and wherein each of said way points comprises:
a position at which a drone is to photograph said field; and
at least one of:
an angle of orientation between said drone and said field at which angle said drone is to photograph said field; and
a distance between said drone and a ground station at which distance said drone is to photograph said field.

7. A method for remotely automatically obtaining two-dimensional images of a field to be surveyed and coordinate data thereof, said method comprising:
providing, by a requesting entity, a request for coordinate data of a plurality of measuring points to be measured in said field;
automatically generating at least a first flight plan and a second flight plan, said first flight plan comprising a plurality of first way points, said second flight plan comprising a plurality of second way points, each of said second way points corresponding to one of said plurality of first way points, each of said plurality of first way points and said plurality of second way points being together suitable for photographing and measuring all of said plurality of measuring points, each of said way points comprising:
a position at which a drone is to photograph said field; and
at least one of:
an angle of orientation between said drone and said field at which angle said drone is to photograph said field; and
a distance between said drone and a ground station at which distance said drone is to photograph said field;
publishing said first and second automatically generated flight plans to a multiplicity of service providers;
providing, by at least some of said service providers to said requesting entity, a quote for executing said first and second automatically generated flight plans;
selecting, by said requesting entity, one of said at least some of said service providers;
executing, by said selected one of said at least some of said service providers, in parallel, said first and second automatically generated flight plans by corresponding first and second drones, said executing comprising, at each of said corresponding ones of said first way points and said second way points:
simultaneously photographing first and second at least partially overlapping sections of said field by corresponding said first and second drones;
obtaining an absolute position of each of said first and second drones;
measuring a distance between said first and second drones;
identifying a plurality of tie-points which appear in both of said first and second at least partially mutually overlapping sections of said field, at least some of said tie-points corresponding to said plurality of measuring points; and
calculating coordinate data of each of said tie points corresponding to said plurality of measuring points by utilizing:
said absolute positions of each of said first and second drones at each of said way-points;
said distance between said first and second drones at each of said way-points; and
at least one of:
an angle of orientation between each of said first and second drones and said field at each of said way-points; and
a distance between each of said first and second drones and a ground station at each of said way-points; and
providing, by said selected one of said at least some of said service providers, said coordinate data of said plurality of measuring points to said requesting entity.

8. A building information modeling method comprising:
for a given construction-site to be surveyed, generating at least a first flight plan and a second flight plan, said first flight plan comprising a plurality of first way points, said second flight plan comprising a plurality of second way points, each of said second way points corresponding to one of said plurality of first way points, each of said plurality of first way points and said plurality of second way points being together suitable for photographing an entirety of said construction-site to be surveyed;
executing, in parallel, said first and second flight plans by corresponding first and second drones, said executing comprising, at each of said corresponding ones of said first way points and said second way points simultaneously photographing first and second at least partially overlapping sections of said construction-site by corresponding said first and second drones; and
in each of said photographs of said first and second at least partially mutually overlapping sections of said construction-site, identifying a plurality of tie-points which appear in both of said first and second at least partially mutually overlapping sections of said construction-site, at least some of said tie-points corresponding to physical unique camera-identifiable markers located throughout said construction-site, thereby generating a three-dimensional point cloud of said construction site.

9. A building information modeling method according to claim 8 and wherein each of said way points comprises:
a position at which a drone is to photograph said construction-site; and
at least one of:
an angle of orientation between said drone and said construction-site at which angle said drone is to photograph said construction-site; and
a distance between said drone and at least one of said physical unique camera-identifiable markers.

10. A building information modeling method according to claim 8 and also comprising ascertaining coordinate data of at least some of said tie points by retrieving and employing pre-measured three-dimensional absolute coordinates of each of said corresponding physical unique camera-identifiable markers.

11. A building information modeling method according to claim 8 and also comprising comparing consecutive ones of said acquired three-dimensional point clouds of said construction site to track progress of a construction project on said construction site.

12. A system for automatically acquiring two-dimensional images of a field to be surveyed and coordinate data thereof, said system comprising:
a flight plan generator operable, for a given field to be surveyed, for generating at least a first flight plan and a second flight plan, said first flight plan comprising a plurality of first way points, said second flight plan comprising a plurality of second way points, each of said second way points corresponding to one of said plurality of first way points, each of said plurality of first way points and said plurality of second way points being together suitable for photographing an entirety of said field to be surveyed; and
at least a first and a second drone operable for executing, in parallel, said first and second flight plans by corresponding first and second drones, said executing comprising, at each of said corresponding ones of said first way points and said second way points:
simultaneously photographing first and second at least partially overlapping sections of said field by corresponding said first and second drones;
obtaining an absolute position of each of said first and second drones; and
measuring a distance between said first and second drones.

13. A system according to claim 12 and wherein each of said way points comprises:
a position at which a drone is to photograph said field; and
at least one of:
an angle of orientation between said drone and said field at which angle said drone is to photograph said field; and
a distance between said drone and a ground station at which distance said drone is to photograph said field.

14. A system according to claim 13 and also comprising:
a tie-point analyzer operable, in each of said first and second at least partially mutually overlapping sections of said field:
for identifying a plurality of tie-points which appear in both of said first and second at least partially mutually overlapping sections of said field; and
for calculating coordinate data of each of said tie points by utilizing:
said absolute positions of each of said first and second drones at each of said way-points;
said distance between said first and second drones at each of said way-points; and
at least one of:
an angle of orientation between each of said first and second drones and said field at each of said way-points; and
a distance between each of said first and second drones and a ground station at each of said way-points.

15. (canceled)

16. A system for remotely automatically obtaining two-dimensional images of a field to be surveyed and coordinate data thereof, said system comprising:
a coordinate data requestor operable for facilitating providing, by a requesting entity, a request for coordinate data of a plurality of measuring points to be measured in said field;
a flight plan generator operable for automatically generating a flight plan to be executed by a drone, which flight plan is operative to direct said drone over said field, said flight plan comprising a multiplicity of way-points at which said drone is to photograph said field and to measure said plurality of measuring points;
a flight plan publisher operable for publishing said automatically generated flight plan to a multiplicity of service providers;
a flight plan quote provider operable for facilitating providing, by at least some of said service providers to said requesting entity, a quote for executing said automatically generated flight plan; and
a service provider selector operable for facilitating selecting, by said requesting entity, at least one of said at least some of said service providers, for executing said automatically generated flight plan and for providing coordinate data of said plurality of measuring points to said requesting entity.

17. A system according to claim 16 and wherein each of said way points comprises:
a position at which a drone is to photograph said field; and
at least one of:
an angle of orientation between said drone and said field at which angle said drone is to photograph said field; and
a distance between said drone and a ground station at which distance said drone is to photograph said field.

18. A system for remotely automatically obtaining two-dimensional images of a field to be surveyed and coordinate data thereof, said system comprising:
a coordinate data requestor operable for facilitating providing, by a requesting entity, a request for coordinate data of a plurality of measuring points to be measured in said field;
a flight plan generator operable for automatically generating at least a first flight plan and a second flight plan, said first flight plan comprising a plurality of first way points, said second flight plan comprising a plurality of second way points, each of said second way points corresponding to one of said plurality of first way points, each of said plurality of first way points and said plurality of second way points being together suitable for photographing and measuring all of said plurality of measuring points, each of said way points comprising:
a position at which a drone is to photograph said field; and
at least one of:
an angle of orientation between said drone and said field at which angle said drone is to photograph said field; and
a distance between said drone and a ground station at which distance said drone is to photograph said field;
a flight plan publisher operable for publishing said first and second automatically generated flight plans to a multiplicity of service providers;
a flight plan quote provider operable for facilitating providing, by at least some of said service providers to said requesting entity, a quote for executing said first and second automatically generated flight plans;
a service provider selector operable for facilitating selecting, by said requesting entity, one of said at least some of said service providers for:
executing, in parallel, said first and second automatically generated flight plans by corresponding first and second drones, said executing comprising, at each of said corresponding ones of said first way points and said second way points:
simultaneously photographing first and second at least partially overlapping sections of said field by corresponding said first and second drones;
obtaining an absolute position of each of said first and second drones;
measuring a distance between said first and second drones;
identifying a plurality of tie-points which appear in both of said first and second at least partially mutually overlapping sections of said field, at least some of said tie-points corresponding to said plurality of measuring points; and
calculating coordinate data of each of said tie points corresponding to said plurality of measuring points by utilizing:
said absolute positions of each of said first and second drones at each of said way-points;
said distance between said first and second drones at each of said way-points; and
at least one of:
an angle of orientation between each of said first and second drones and said field at each of said way-points; and
a distance between each of said first and second drones and a ground station at each of said way-points; and
providing said coordinate data of said plurality of measuring points to said requesting entity.

19. A building information modeling system comprising:
a flight plan generator operable, for a given construction-site to be surveyed, for generating at least a first flight plan and a second flight plan, said first flight plan comprising a plurality of first way points, said second flight plan comprising a plurality of second way points, each of said second way points corresponding to one of said plurality of first way points, each of said plurality of first way points and said plurality of second way points being together suitable for photographing an entirety of said construction-site to be surveyed;
at least a first and a second drone operable for executing, in parallel, said first and second flight plans by corresponding first and second drones, said executing comprising, at each of said corresponding ones of said first way points and said second way points, simultaneously photographing first and second at least partially overlapping sections of said construction-site by corresponding said first and second drones; and
a tie-point analyzer operable, in each of said photographs of said first and second at least partially mutually overlapping sections of said construction-site, for identifying a plurality of tie-points which appear in both of said first and second at least partially mutually overlapping sections of said construction-site, at least some of said tie-points corresponding to physical unique camera-identifiable markers located throughout said construction-site, thereby generating a three-dimensional point cloud of said construction site.

20. A building information modeling system according to claim 19 and wherein each of said way points comprises:
a position at which a drone is to photograph said construction-site; and
at least one of:
an angle of orientation between said drone and said construction-site at which angle said drone is to photograph said construction-site; and
a distance between said drone and at least one of said physical unique camera-identifiable markers.

21. A building information modeling system according to claim 19 and wherein said tie-point analyzer is also operable for ascertaining coordinate data of at least some of said tie points by retrieving and employing pre-measured three-dimensional absolute coordinates of each of said corresponding physical unique camera-identifiable markers.

22. A building information modeling system according to claim 19 and also comprising a building information modeler operable for comparing consecutive ones of said acquired three-dimensional point clouds of said construction site to track progress of a construction project on said construction site.
